(19) United States
(12) Patent Application Publication
(10) Pub. No.: US 2010/0301220 A1
(43) Pub. Date: Dec. 2, 2010

(54) RADIATION DETECTOR

(75) Inventors: Robert John Ott, Axminster (GB); Richard Stephenson, Wallingford (GB)

Correspondence Address: BIRCH STEWART KOLASCH & BIRCH, PO BOX 747, FALLS CHURCH, VA, 22040-0747, US

(73) Assignee: PETRRA LTD.

(21) Appl. No.: 12/600,203

(22) PCT Filed: Apr. 29, 2008
(86) PCT No.: PCT/GB08/01502

§ 371 Date: Nov. 13, 2009

(30) Foreign Application Priority Data
May 15, 2007 (GB) 0709381.8

(51) Int. Cl. G01T 1/164; G01T 1/20; G01T 1/208

(52) U.S. Cl. 250/363.03; 250/361 R; 250/369

(57) ABSTRACT

A gamma ray detector is disclosed. A scintillation layer (60), for example of barium fluoride, is formed of a plurality of adjacent elongate rods, each rod being elongate within the plane of the layer, and being provided with a plurality of slots (62) distributed along the length of the rod and extending in a width direction also coplanar with the layer. Behind the scintillation layer a sensor determines a position of uv photons exiting the layer.

### FIELD OF THE INVENTION

The present invention relates to a radiation detector. Exemplary embodiments provide a gamma ray detector or camera having a scintillation layer formed of a material such as barium fluoride, an adjacent low pressure gas space, and a locator arranged to detect the position of an electron burst travelling through the gas space.

### INTRODUCTION

Positron emission tomography (PET) is a well know technique in which a human or animal subject is given a dose of a tracer labelled with a positron-emitting radioisotope. A positron emitted from the radioisotope nucleus within the subject interacts with an atomic electron within a short distance of travel. The electron-positron pair annihilate to form two 511 keV gamma rays which travel away from the point of decay almost co-linearly. Gamma ray detectors disposed about the subject are used to detect these pairs of gamma rays in time coincidence, and the source of decay is assumed to be directly between the detected positions of the coincident gamma rays. An image of the biodistribution of the tracer within the subject is constructed using tomographic techniques from many such coincidences.

Commercial PET scanners generally use many hundreds or thousands of separate scintillation detectors coupled to photomultipliers, disposed around the subject. An alternative technology using a pair of large area gamma ray detectors is disclosed in WO93/08484. In this alternative technology, each detector has a planar scintillation layer extending across about a quarter of a square meter, composed of a plurality of barium fluoride tiles each about 10 mm thick. A gamma ray incident upon the scintillation layer generates several ultraviolet (uv) photons (wavelength<300 nm) which are emitted into a 4π solid angle around the gamma ray interaction point. A fraction of these ultraviolet photons pass into a low pressure gas space containing TMAE (tetrakis (dimethylamino) ethylene) gas which is photoionized by the uv photons within a region of high electric field to produce several photo-electrons. The resulting electrons are accelerated into a multi-wire proportional chamber (MWPC) via a high voltage (˜1600 volts) which amplifies the signal to produce a pulse large enough to allow measurement of the time, energy and position of the burst.

In order for an image of the subject to be accurately reconstructed, the detected position of the burst should reflect as accurately as possible the point of incidence of the gamma ray at the scintillation layer. The resolution of positron emission tomography is inherently limited to a millimetre or so by factors such as the distance of travel of the positron in an unknown direction before annihilation into two gamma rays, and the slight deviation from 180 degrees of the angle between the resulting two gamma rays which occurs if the annihilation of the positron happens before it comes to rest. It is generally desirable for a gamma ray detector used in positron emission scanning to have at least a corresponding spatial resolution. In WO93/08484 the scintillation tiles are 10 mm thick. The typical exit cone angle of ultraviolet photons formed in the scintillation layer gives rise to an electron burst within the low pressure gas space with an acceptable spatial resolution and accuracy of a few millimetres.

It is also generally desirable, to detect as high a proportion of the emitted gamma rays as possible, to build up the data required to reconstruct an image of the required signal to noise ratio in as short a time as possible. Using barium fluoride scintillation tiles which are 10 mm thick helps maintain good spatial accuracy, but tiles of this thickness generate uv photons from only about 25% of the incident 511 MeV gamma rays. Thicker tiles could be used to detect more of the gamma rays, but the lateral spread of the exit cone of the ultraviolet photons increases in size when travelling through the thicker scintillation layer, thereby adversely affecting the spatial resolution of the detector.

It would therefore be desirable to provide a gamma radiation detector having a thicker scintillation layer to more efficiently detect incident gamma rays, with minimal adverse affect on the spatial resolution and accuracy of the detector. The invention seeks to address this and other problems of the related prior art.

### SUMMARY OF THE INVENTION

Accordingly the present invention provides a gamma ray detector comprising: a scintillation layer for converting a gamma ray photon into a plurality of ultraviolet photons; wherein the scintillation layer comprises a plurality of adjacent elongate rods formed of a scintillation material, each rod being elongate along a length coplanar with the layer. For the purposes of the discussion below, each rod may be considered to also have a width dimension, which is also coplanar with the layer, and a depth dimension extending through the thickness of the layer.

Typically, the scintillation layer has opposing first and second sides. A gamma ray photon is received at the first side, and at least some of the resulting ultraviolet photons are then received at and exit at the second side. The detector is adapted to determine the position of the photons received at the second side, for example by detecting photons emerging from the second side into a sensor structure. Such a sensor may be adjacent to and extend across the second side of the scintillation layer.

The spatial resolution obtained from a sheet of scintillation material is determined by the spread of the light spot produced by the scintillation process. This in turn depends on the thickness of the sheet, with a thicker sheet leading to a broader spread of the spot and a worse resolution. On the other hand, to improve gamma ray detection efficiency it is necessary to make the sheet thicker, and to do this without loss of spatial resolution it is necessary to limit the spread of the light spot in some way. To achieve this the invention provides fingers or rods of scintillation crystal, which makes it possible to obtain a spatial resolution of less than the rod width in that direction, because the sides of the rod confine the spread of the ultraviolet photons.

According to the invention each rod is cut with a plurality of slots. The slots are distributed along the length of each rod. Each slot extends across a part, or more preferably the full width of the rod, and across a part of the depth. While the use of rods confines the spread of photons in the width direction, the slots confine the spread of photons in the length direction and improve the spatial resolution of the detector in that direction.

Preferably, each slot extends from the first side of the scintillation layer part way towards the second side. Photons generated close to the first side travel in a cone which spreads towards the second side. Each slot preferably extends around 50% through the depth of the rod, in particular between about 40% and 60%.

There are practical limitations to the dimensions of the rods, depending on the materials used, the surrounding support structure, and the aim of maintaining or improving spatial resolution while also increasing the depth of the scintillation layer. Generally, however, length of each rod may be at least 10 times greater than the width and at least 4 times greater than the depth of the rod, and the width of each rod may be less than half the depth of the rod. The scintillation layer preferably comprises at least a hundred, and more preferably several hundred rods.

The sensor may comprise a low pressure gas space adjacent to and/or extending across the second side of the scintillation layer and a locator for determining a position within the detector of a burst of electrons deriving from ultraviolet photons generated within the scintillation layer and moving through the gas space, such that the determined position corresponds to the position of the ultraviolet photons emerging from the scintillation layer. Preferably, the sensor determines coordinates within the plane of the detector for each electron burst arriving at the sensor, and hence the coordinates at the scintillation layer of a corresponding gamma ray.

The low pressure gas space may contain a photoionizing gas for converting the ultraviolet photons generated within the scintillation layer into the burst of electrons.

In the described embodiments the scintillation crystal rods are formed of barium fluoride, and the photoionizing gas is TMAE gas, although other arrangements and materials could be used.

The invention also provides a positron emission scanner implementing the above. Such a scanner may comprise: two or more detectors as described above; and a reconstruction element, such as a suitably programmed computer, adapted to combine the position data relating to bursts of electrons determined to be time coincident at the sensors of both detectors, to thereby form an image of a subject disposed between the detectors. Advantageously, each detector may further comprise a gate-plane disposed within the low pressure gas space and coupled to a controller, the controller being adapted to control each gate to allow a burst of electrons to pass to the position sensing part of the detector only when bursts of electrons determined to be time coincident are sensed in two opposing detectors.

The invention also provides corresponding methods of providing and operating gamma ray detectors and position emission scanners.

### BRIEF DESCRIPTION OF THE DRAWINGS

Embodiments of the invention will now be described, by way of example only, with reference to the accompanying drawings, of which:

FIG. 1 illustrates PET imaging using two gamma ray detectors embodying the invention—in this case the detectors are mounted on a rotatable gantry to allow 3D imaging;

FIG. 2 is a sectional schematic of the scintillation layer and electrode structure of a detector of FIG. 1;

FIG. 3 is a perspective view of a frame holding a plurality of rods of scintillation material to form a scintillation layer of FIG. 2; and

FIG. 4 is a perspective view of one of the slotted scintillation rods of FIG. 3.

FIG. 5 is a graph of modelled spatial resolution using different slot depths.

### DETAILED DESCRIPTION OF EMBODIMENTS

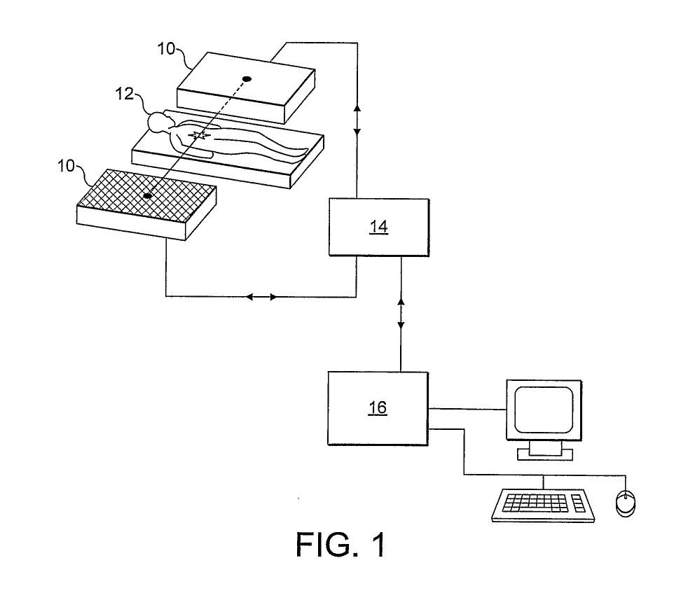

Referring now to FIG. 1 there is shown a positron emission scanner comprising two gamma ray detectors 10 disposed at either side of a human, animal or other subject 12. The detectors 10 are connected to common control and data processing circuitry 14 which provides operation control of the two cameras and outputs data relating to coincident gamma rays, detected at the same time by both cameras. Output data is passed to a computer 16 which uses the coincidence data to reconstruct an image of the tracer biodistribution within the subject 12 using known tomographic reconstruction techniques.

Generally, each detector comprises a scintillation layer. A gamma ray received at a first side of the scintillation layer gives rise to a number of ultraviolet photons, at least some of which are detected, or emerge for subsequent detection, at a second, opposite side of the scintillation layer. The position of the photons provides a position of the received gamma ray.

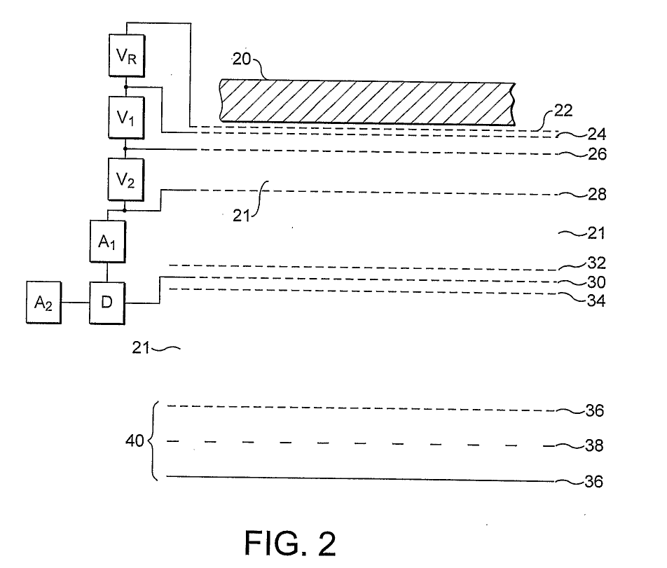

The gamma ray detectors may take various detailed forms. FIG. 2 illustrates, schematically, a section through a suitable gamma ray detector 10, from a scintillation layer 20 formed of tiles of barium fluoride (BaF₂) crystals, to a position locator provided by a multi-wire proportional counter (MWPC) 40, which is adapted to detect a position, in particular coordinates in the major plane of the detector, of an electron burst generated in the detector by an incident gamma ray. Between the scintillation layer 20 and counter 40 is a low pressure gas space 21 which contains heated TMAE gas (tetrakis(dimethylamino)ethylene) at a pressure of about 4 mb at 60° C., which has a photoionization potential of 5.36 eV, making it suitable for amplifying the approximately 190 nm photons emitted by the BaF₂. Details of the construction and operation of a detector as shown in FIG. 2 are set out in WO93/08484, but in brief the detector is arranged as follows.

Conductive wire 22 of 25 μm diameter is wound around each BaF₂ crystal with a 250 μm pitch. A first wire plane 24 consisting of 50 μm diameter wire at a pitch of 500 μm is spaced 0.5 mm from the scintillation layer 20. A second plane 26 consisting of 100 μm wire at 1 mm pitch is spaced 3.0 mm from the first plane. A third plane 28 also consists of 100 μm diameter wire at 1 mm pitch spaced 9.0 mm from the second plane. A gate 30 comprising 100 μm wires at 1 mm pitch is positioned 20 mm from the third wire plane and has first and second metallic copper mesh screens 32, 34 positioned one on either side. The MWPC is spaced 13.2 mm beyond the gate and is consists of two cathode planes 36 formed of 50 μm wire at 2.0 mm pitch and an anode/cathode plane 38 of 20 μm anode wires perpendicular to 100 μm cathode wires at 4.0 mm pitch. Delay lines are used to read the magnitude and x/y coordinates of an electron burst from the anode/cathode plane.

Incident gamma radiation causes the BaF₂ crystal of layer 20 to scintillate, generating ultra violet photons. Some of the UV photons convert in the low pressure gas space adjacent to the crystal, and the resulting electrons are avalanche amplified in the V₁=300 V/mm electric field applied between the first and second planes and the lower V₂=150 V/mm electric field applied between the second and third planes. A small reverse bias V_{R}<100 Volts is applied to the mesh 22 to prevent build up of positive ions at the scintillation layer. The use of two separate acceleration regions, between the first and second, and second and third planes, permits sufficient electron cascade amplification without instabilities.

The gate electrode 30 is normally biased by ±30 V on alternate wires, which causes the electrode to act as a barrier to passing electron bursts. If a passing electron burst is detected at the third plane 28, this first signal being represented in FIG. 2 by current A₁, and an electron burst is detected at the same time at the third plane of the other, complementary gamma ray detector, this second signal being represented in FIG. 2 by current A₂, then coincidence detector D brings the voltages of the gate electrode wires together to allow the electron burst to pass on to the MWPC. In this way, gamma rays having no coincidence at the other detector do not lead to a signal at the MWPC, so that the duty cycle of the MWPC is dramatically reduced, by a factor of up to 100. The coincidence detector D may form part of the common control and data processing circuitry shown as 14 in FIG. 1.

The signal applied to the gate is of very high frequency, and the copper mesh screens 32, 34 positioned either side of the gate, which are held at a voltage consistent with drift of electrons past the gate and on towards the MWPC, act to shield this high frequency signal from the rest of the detector.

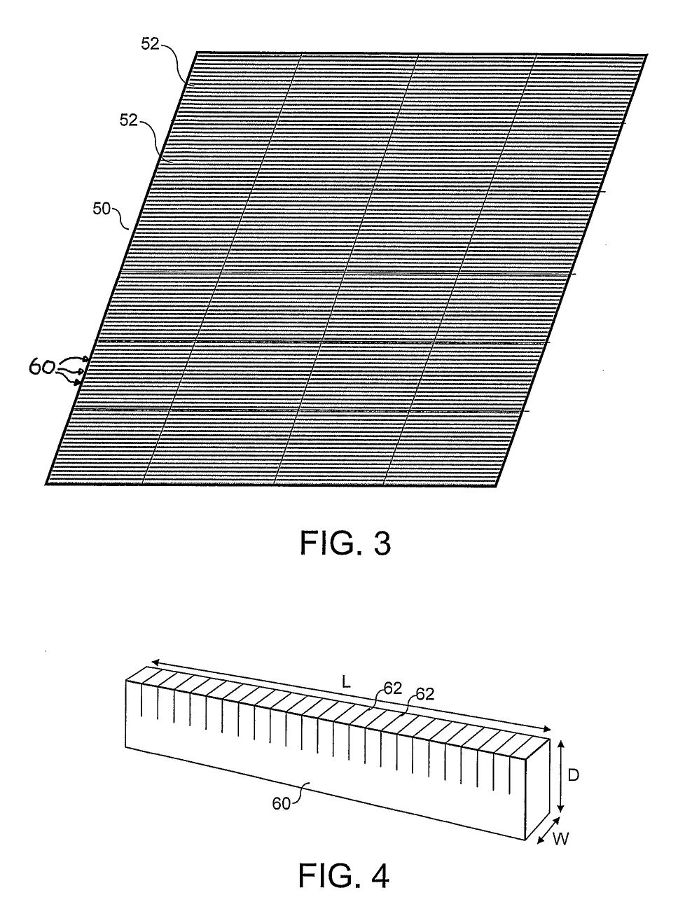

FIG. 3 illustrates a construction of the scintillation layer. A rectangular stainless steel frame having sides of about 40 cm and 60 cm forms 24 bays 52 of 10 cm by 10 cm. Each bay holds an array of adjacently stacked of BaF₂ crystal rods 60 each of which is aligned to lie in the plane of the scintillation layer. In other words, the direction of elongation of each rod, or the length “l” is at least locally coplanar with the scintillation layer. As shown in FIG. 4 each crystal rod is about 10 cm long (elongate dimension “l”), about 5 mm in a width direction (“w”) also at least locally coplanar with the scintillation layer, and about 25 mm thick through the depth (“d”) of the layer. Slots 62 are provided extending across the width of the rod, spaced apart evenly along the length of the rod, and penetrating part way through the depth of the rod. In FIG. 4 the slots are spaced by about 5 mm, and penetrate about half way through the rod.

The slots should most preferably be cut into the face of the scintillation layer at which the gamma ray photons are to be received. Cutting the slots into the face at which the ultraviolet photons emerge reduces the amount of light emerging from the rods by about 50%, and gives rise to a spatial resolution which depends strongly on the relative position of a received gamma ray and a slot, with a slot acting to split photons from one gamma ray into two regions of the rod.

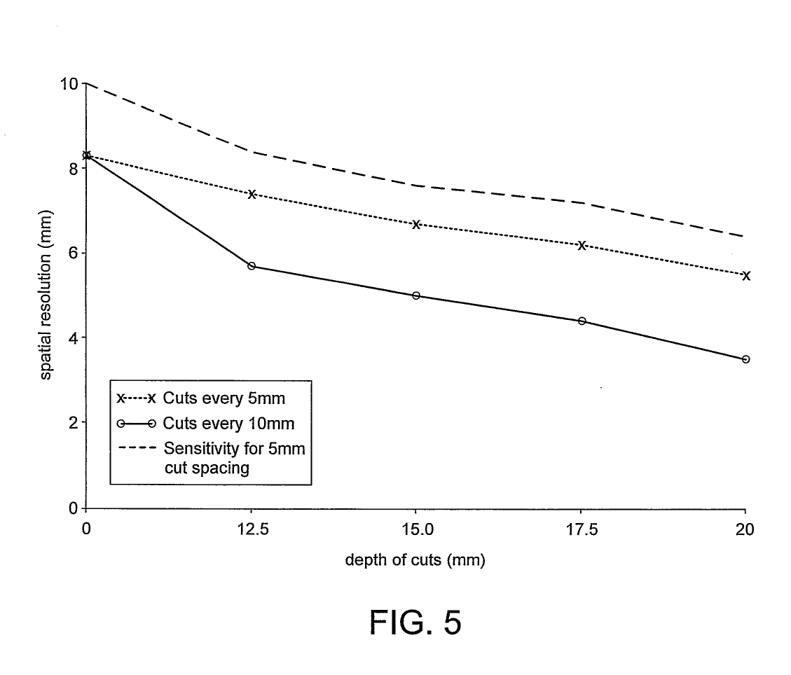

FIG. 5 illustrates the effect of placing slots of particular depths at spacings of either 5 mm or 10 mm along the length of each rod. The abscissa represents the depth of the slots into the first (external) face of the 25 mm thick rods, and the ordinate the calculated resulting spatial resolution of the gamma ray detector in the rod length direction. A third curve illustrates the sensitivity (in arbitrary units) which results from loss of light due to increased scatter and loss at slot boundaries.

It can be seen that deeper slots give rise to finer resolution, but also more photon loss and hence lower sensitivity. The optimum slot depth to achieve a desirable 5 to 6 mm resolution appears to be about half way through, for example between about 40% and 60% of the rod thickness.

For a target resolution of about 5 or 6 mm the slot spacing along the rod length should also be about this size, for example in the range 4 mm to 8 mm.

The dimensions of the rods may be adapted in various ways according to the specific requirements of a particular detector, as discussed more fully below. Generally, however, each rod is expected to be at least five times greater in length than in width or depth, and expected to be at least two times greater in depth than width. Typical suitable dimensions may be depth from 15 mm to 30 mm, width from 4 mm to 12 mm, and length from 50 mm to 250 mm.

Dividing the scintillation layer into rods aligned with the layer permits a thicker layer to be used while mitigating the loss of spatial resolution of the detector this would otherwise cause. In particular, the divisions between the rods reduces the lateral distance, in the width direction of the rods, Over which uv photons generated within the layer can travel before entering the low pressure gas space. The provision of slots in each rod, as illustrated in FIG. 4, similarly limits the lateral distance in the length direction of the rods, over which uv photons can travel. The lateral travel of uv photons in directions coplanar with the scintillation layer, within the layer, is thereby reduced. However, the rods are still reasonably practical to handle and assemble into a frame or other structure to complete the scintillation layer. This is particularly important in larger area detectors, where even using this technique, hundreds of rods may be required.

The rods may be manufactured by cutting larger crystals of BaF₂, for example with a diamond saw or laser, and polishing all external surfaces. The slots may also be formed by cutting with a diamond saw or laser. The width of each slot along the direction of the rod length is preferably less than 400 microns. The slots may be left rough sawn, or could be polished to increase internal reflection. The slots may be filled with a material to improve the strength of each rod, and such a measure may allow the slots to be cut much deeper through the depth of the rod while maintaining adequate robustness and strength. Any such filling material should not be soluble in the gas used in the low pressure chamber.

A scintillation layer with a thickness of less than about 10 mm allows relatively little lateral travel of uv photons in the resolution context of PET scanning. The use of rods as described herein to limit lateral travel of uv photons generated from 511 MeV photons in BaF₂ is therefore mostly advantageous when the thickness of the layer is more than 10 mm, and preferably more than about 18 mm. The thickness of the layer may be usefully increased to around 30 mm before increased optical light absorption losses outweigh the diminishing returns of increased gamma ray capture efficiency.

The width of each rod, for the described energies and materials, should probably be less than about 20 mm, and preferably less than about 10 mm. Similarly again, the spacing between each slot should probably be less than about 20 mm and preferably less than about 10 mm. In the embodiment shown in FIG. 4 the rod width and slot spacing is about 5 mm. Smaller widths and spacings may be used, practically down to about 3 or 4 mm but with an increasing penalty of loss of scintillation volume and loss of photons at scattering boundaries, especially when rods having a depth of much more than 10 mm are used.

An increased slot depth is expected to improve the spatial resolution of the detector, but will tend to weaken the rods, so that for deep slots shorter rods may be necessary. Furthermore, deeper slots lead to increased loss of ultraviolet photons through scattering and absorbtion. Preferably, the slots should be through about 50%, for example between 40% and 60% of the rod thickness.

The elongate form of each rod provides advantages in ease of handling of the rods and construction of the scintillation layer. However, longer rods are more fragile and likely to be damaged or break in handling, or after construction of the layer, while shorter rods are likely to require more structural supporting framework and work in constructing the layer. For BaF₂ rods similar to those shown in FIG. 4 a length of between about 50 mm and 200 mm is reasonably practical. Longer rods might be used where slots are cut to a lesser depth or not at all.

The detector, and consequently the scintillation layer may be of a variety of sizes depending on the intended application. For example, a gamma ray detector for a large engineering application or for whole body scanning could have an area of 1 square meter of more, while a small detector might have an area of perhaps only 10 square centimetres. The numbers and dimensions of the rods may be selected accordingly, along with a suitable framework for supporting the rods.

Scintillation materials other than BaF₂, such as NaI(Tl), LSO or BGO could be used to form the scintillation rods, although BaF₂ is the only readily available phosphor that can be used with TMAE gas because of the fast emission of short wavelength uv photons at around 190 nm. The rods could be used, however, within gamma ray detectors having different general constructions to the gas based detector described above, for example one using multiple photomultipliers or avalanche photodiodes as light sensors, or different photoionization arrangements in a gas based detector.

Although a largely planar scintillation layer is illustrated in FIG. 3, the layer could be curved or have discontinuities, with the rods being substantially coplanar with the local plane of the layer as appropriate.

Although the TMAE gas in the described embodiments, or more generally the sensor of UV photons, is discussed as being adjacent to the scintillation layer, this does exclude the possibility of intervening layers which could, for example, be used to provide structural integrity or support to the scintillation rods, or for other purposes.

1. A gamma ray detector comprising:
a scintillation layer, having opposing first and second sides, for converting a gamma ray photon received at the first side into a plurality of ultraviolet photons at least some of which are received at and exit through the second side; and
a sensor adapted to determine a position of the exiting photons,
wherein the scintillation layer comprises a plurality of adjacent elongate rods formed of a scintillation material, each rod being elongate along a length coplanar with the layer, having a width also coplanar with the layer, and having a depth through the layer, and each rod is provided with a plurality of slots distributed along the length of the rod and extending in the width direction.

2. The gamma ray detector of claim 1 wherein the sensor comprises a low pressure gas space extending across the second side of the scintillation layer; and
a locator for determining a position within the detector of a burst of electrons corresponding to the position of the ultraviolet photons emerging from the second side.

3. The detector of claim 2 wherein the low pressure gas space contains a photoionizing gas for converting said ultraviolet photons into said burst of electrons.

4. The detector of claim 3 wherein the photoionizing gas is TMAE gas.

5. The detector of claim 2 wherein the detector is arranged to provide an electric field, within the low pressure gas space, to cause avalanche amplification of said burst of electrons.

6. The detector of claim 1 wherein each slot extends across the full width of the rod, and part way through the depth of the rod.

7. The detector of claim 1 wherein each slot extends from the first side of the scintillation layer part way towards the second side.

8. The detector of claim 6 wherein each slot extends at least 50% through the depth of the rod.

9. The detector of claim 6 wherein each slot extends between about 40% and 60% through the depth of the rod.

10. The detector of claim 6 wherein the spacing along the length of the rod between each slot is less than half the depth of the rod.

11. The gamma ray detector of claim 1 wherein the sensor is adapted to detect the position, in the plane of the scintillation layer, of ultraviolet photons emerging from the second side.

12. The detector of claim 1 wherein the length of each rod is at least ten times greater than the width of the rod.

13. The detector of claim 1 wherein the length of each rod is at least four times greater than the depth of the rod.

14. The detector of claim 1 wherein the width of each rod is less than half the depth of the rod.

15. The detector of claim 1 wherein the scintillation rods are formed of barium fluoride.

16. The detector of claim 1 wherein the depth of each rod is in the range from 15 mm to 30 mm, the width of each rod is from 4 mm to 12 mm, and the length of each rod is from 50 mm to 250 mm.

17. A positron emission scanner comprising:
at least two detectors as set out in claim 2; and
a reconstruction element adapted to combine the position data relating to detected gamma rays determined to be time coincident at the sensors of both detectors, to thereby foam an image of a subject disposed between the detectors.

18. The positron emission scanner of claim 17 further comprising a controller,
each detector further comprising a gate disposed within the low pressure gas space and coupled to the controller, the controller being adapted to control each gate to allow a burst of electrons to pass to the locator when bursts of electrons determined to be time coincident are sensed in both detectors.

19. The detector of claim 7 wherein each slot extends at least 50% through the depth of the rod.

20. The detector of claim 7 wherein each slot extends between about 40% and 60% through the depth of the rod.
